(19) United States
(12) Patent Application Publication
(10) Pub. No.: US 2013/0147917 A1
(43) Pub. Date: Jun. 13, 2013

(54) COMPUTING DEVICE AND HOUSEHOLD MONITORING METHOD USING THE COMPUTING DEVICE

(71) Applicants: HOU-HSIEN LEE, Tu-Cheng (TW); CHANG-JUNG LEE, Tu-Cheng (TW); CHIH-PING LO, Tu-Cheng (TW)

(72) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/563,828

(22) Filed: Aug. 1, 2012

(30) Foreign Application Priority Data
Dec. 13, 2011 (TW) 100145920

(51) Int. Cl. H04N 7/18; H04N 13/02

(52) U.S. Cl. 348/46; 348/E13.074; 348/E07.085

(57) ABSTRACT

In a household monitoring method using a computing device, the computing device is connected to one or more depth-sensing cameras and an alarm device. The computing device controls the depth-sensing cameras to capture real-time images of monitored areas in front of the depth-sensing cameras. A presence of a person is detected from the images. If the person is detected to be in exigency, the computing device notifies relevant personnel of the exigency.

### BACKGROUND

1. Technical Field

The embodiments of the present disclosure relate to surveillance technology, and particularly to a computing device and a household monitoring method using the computing device.

2. Description of Related art

Nursing care is important for infants and the elderly. Because of the constant attention that must be given to infants and the elderly, nursing personnel may not notice an accident that occurs to an infant or an elderly person under their care. Therefore, there is a need for improvement in the art.

### BRIEF DESCRIPTION OF THE DRAWINGS

FIG. 1 is a block diagram of one embodiment of a computing device including a household monitoring system.

FIG. 2 is a flowchart of one embodiment of a household monitoring method of the computing device in FIG. 1.

FIG. 3 is one embodiment illustrating depth-sensing cameras installed at different positions of a house.

FIG. 4 is one embodiment illustrating a rectangle bounding a person detected from an image.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

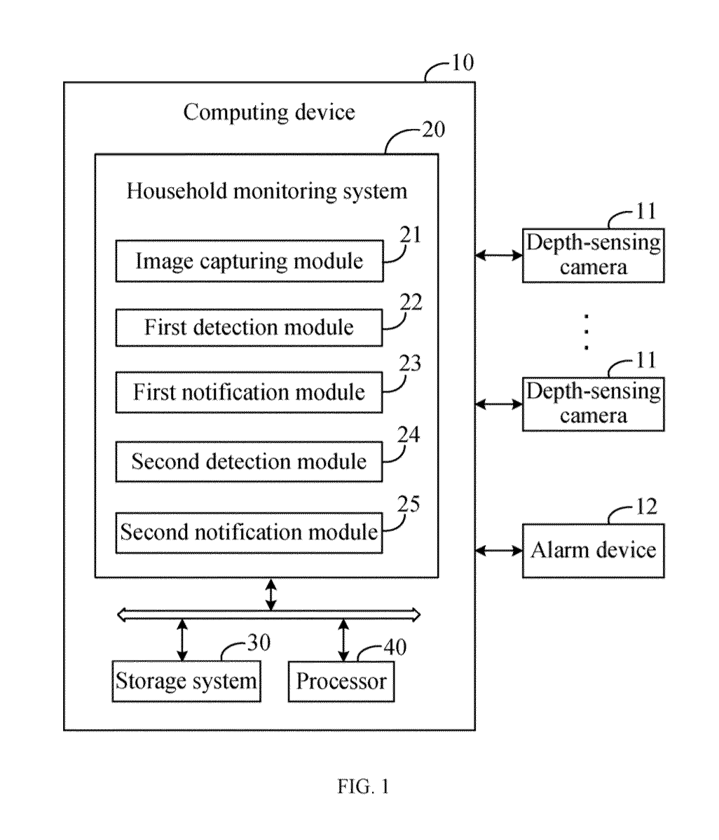

FIG. 1 is a block diagram of one embodiment of a computing device 10. The computing device 10 includes a household monitoring system 20. The computing device 10 is connected to a plurality of depth-sensing cameras 11 and an alarm device 12 (e.g., a buzzer or a warning light). Each of the depth-sensing cameras 11 may be a time-of-flight (TOF) camera. Each of the depth-sensing cameras 11 can obtain a distance between a lens of the depth-sensing camera 11 and each point on an object to be captured, so that each image captured by the depth-sensing camera 11 includes the distance information between the lens and each point on the object in the image.

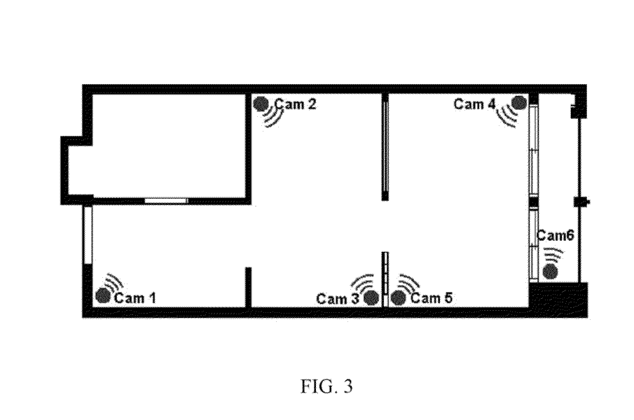

The depth-sensing cameras 11 are installed at different positions for capturing images of different monitored areas in front of the depth-sensing cameras 11. In one embodiment with respect to FIG. 3, six depth-sensing cameras 11 denoted as Cam1, Cam2, . . . , and Cam6 are installed at different positions (e.g., drawing room, bedroom, and balcony) of a house. The household monitoring system 20 determines whether a person is in exigency by analyzing the images.

In this embodiment, the computing device 10 further includes a storage system 30 and at least one processor 40. The storage system 30 may be a dedicated memory, such as an erasable programmable read only memory (EPROM), a hard disk driver (HDD), or flash memory. In some embodiments, the storage device 11 may also be an external storage device, such as an external hard disk, a storage card, or a data storage medium.

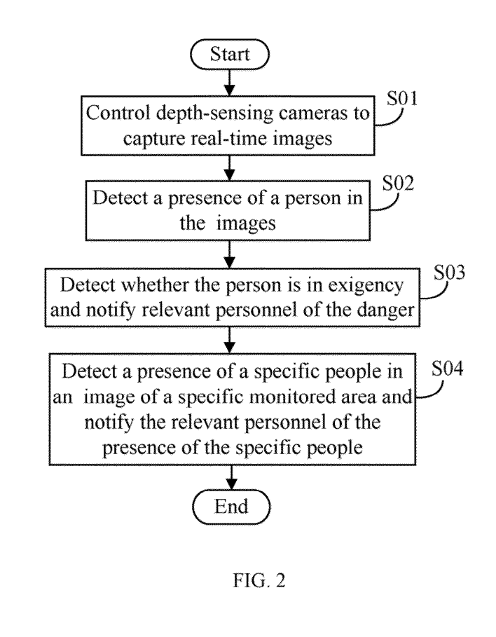

The household monitoring system 20 includes an image capturing module 21, a first detection module 22, a first notification module 23, a second detection module 24, and a second notification module 25. The modules 21-25 may comprise computerized code in the form of one or more programs that are stored in the storage system 30. The computerized code includes instructions that are executed by the at least one processor 40, to provide the aforementioned functions of the household monitoring system 20. A detailed description of the functions of the modules 21-25 is given below and in reference to FIG. 2.

FIG. 2 is a flowchart of one embodiment of a household monitoring method of the computing device 10 in FIG. 1. Depending on the embodiment, additional steps may be added, others removed, and the ordering of the steps may be changed.

In step S01, the image capturing module 21 controls each of the depth-sensing cameras 11 to capture a real-time image of a monitored area in front of the depth-sensing camera 11. As mentioned above, each image includes distance information between the lens of the depth-sensing camera 11 and each point on the object in the image. In one embodiment, the image capturing module 21 may turn off one or more depth-sensing cameras 11 for a monitored area (e.g., a bedroom) if the monitored area does not need to be monitored.

In step S02, the first detection module 22 detects a presence of a person in the images. In one embodiment, the first detection module 22 applies a template matching method or an appearance-based statistical method to detect the presence of the person in the images. The first detection module 22 may detect the presence of the person in the images according to the distance information of the images.

The template matching method may include steps of: pre-storing a set of human feature samples and a set of non-human feature samples in the storage system 30, creating a human image sample database according to the human feature samples and the non-human feature samples, and identifying whether the person is present in the images by comparing each of the images with samples of human images in the human image sample database. The human feature samples may include frontal images, profile images, and rear images. In one embodiment, the human image sample database may be created using an artificial neural network algorithm or an adaptive boosting algorithm.

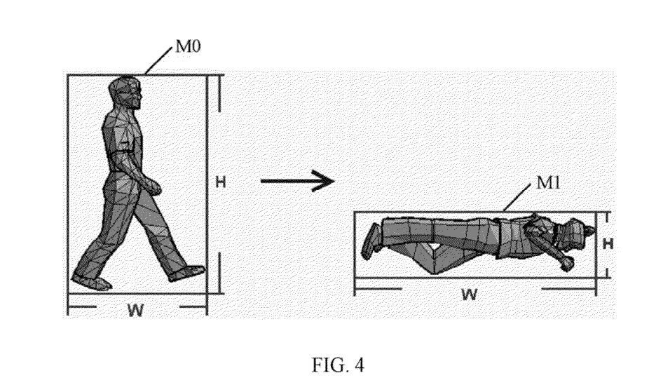

When the person is detected from the images, in step S03, the first detection module 22 detects whether the person is in exigency by analyzing an image containing the person. In one embodiment with respect to FIG. 4, the first detection module 22 restricts the person in a rectangle (denoted as “M0”) in an image containing the person. The first detection module 22 determines whether a ratio of change of a height (denoted as “H”) or a width (denoted as “W”) of the rectangle is larger than a predetermined value (e.g., 60%) for a preset time interval (e.g., 30 seconds). If the ratio of change of the height or the width of the rectangle is larger than a predetermined value for a preset time interval, the first detection module 22 determines that the person is in exigency. In one example with respect to FIG. 4, the rectangle bounding the person changes from “M0” to “M1”. The ratio of change of the height is larger than 60% for 30 seconds, which indicates an accident of fall of the person. Then the first detection module 22 detects that the person is in exigency.

If the person is detected in exigency, the first notification module 23 notifies relevant personnel of the exigency of the person. Depending on the embodiment, the first notification module 23 may send first alarm information to the relevant personnel via the alarm device 12, e-mails, or short message service (SMS) messages.

In step S04, the second detection module 24 detects a presence of a specific person (such as an infant) in an image of a specific monitored area. Samples of human images of the specific person may be pre-stored in the storage system 30. The second detection module 24 compares the image of the specific monitored area with the samples of human images of the specific person to detect whether the specific person is present at the specific monitored area.

When the specific person is detected present in the image of the specific monitored area, the second notification module 25 notifies the relevant personnel of the presence of the specific person in the image of the specific monitored area, which indicates there is a potential risk to the specific person. The second notification module 25 may send second alarm information to the relevant personnel via the alarm device 12, e-mails, or short message service (SMS) messages.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A household monitoring method being executed by a processor of a computing device, the method comprising:
controlling a plurality of depth-sensing cameras connected to the computing device to capture real-time images of monitored areas in front of the depth-sensing cameras;
detecting a presence of a person in the images;
detecting whether the person present in the images is in exigency; and
notifying relevant personnel of the exigency upon condition that the person is in exigency.

2. The method of claim 1, further comprising:
detecting a presence of a specific person in an image of a specific monitored area; and
notifying the relevant personnel of the presence of the specific person in the image of the specific monitored area.

3. The method of claim 1, wherein the person is detected by comparing each of the images with samples of human images.

4. The method of claim 1, wherein the person is detected using a template matching method or an appearance-based statistical method.

5. The method of claim 1, wherein each of the depth-sensing cameras obtains a distance between a lens of the depth-sensing camera and each point on an object to be captured, and each of the images includes distance information between lens of the depth-sensing camera and each point on the object in the image, and wherein the person is detected according to the distance information of the object in the image.

6. The method of claim 1, wherein each of the depth-sensing cameras is a time-of-flight (TOF) camera.

7. A computing device, comprising:
a storage system;
at least one processor; and
a household monitoring system comprising one or more programs that are stored in the storage system and executed by the at least one processor, the one or more programs comprising instructions to:
control a plurality of depth-sensing cameras connected to the computing device to capture real-time images of monitored areas in front of the depth-sensing cameras;
detect a presence of a person in the images;
detect whether the person present in the images is in exigency; and
notify relevant personnel of the exigency upon condition that the person is detected in exigency.

8. The computing device of claim 7, wherein the one or more programs further comprise instructions to:
detect a presence of a specific person in an image of a specific monitored area; and
notify the relevant personnel of the presence of the specific person in the image of the specific monitored area.

9. The computing device of claim 7, wherein the person is detected by comparing each of the images with samples of human images.

10. The computing device of claim 7, wherein the person is detected using a template matching method or an appearance-based statistical method.

11. The computing device of claim 7, wherein each of the depth-sensing cameras obtains a distance between a lens of the depth-sensing camera and each point on an object to be captured, and each of the images includes distance information between lens of the depth-sensing camera and each point on the object in the image, wherein the person is detected according to the distance information of the object in the image.

12. The apparatus of claim 7, wherein each of the depth-sensing cameras is a time-of-flight (TOF) camera.

13. A non-transitory computer-readable storage medium storing a set of instructions, the set of instructions capable of being executed by a processor of a computing device to implement a household monitoring method, the method comprising:
controlling a plurality of depth-sensing cameras connected to the computing device to capture real-time images of monitored areas in front of the depth-sensing cameras;
detecting a presence of a person in the images;
detecting whether the person present in the images is in exigency; and
notifying relevant personnel of the exigency upon condition that the person is detected in exigency.

14. The storage medium of claim 13, wherein the method further comprises:
detecting a presence of a specific person in an image of a specific monitored area; and
notifying the relevant personnel of the presence of the specific person in the image of the specific monitored area.

15. The storage medium of claim 13, wherein the person is detected by comparing each of the images with samples of human images.

16. The storage medium of claim 13, wherein the person is detected using a template matching method or an appearance-based statistical method.

17. The storage medium of claim 13, wherein each of the depth-sensing cameras obtains a distance between a lens of the depth-sensing camera and each point on an object to be captured, each of the images includes distance information between lens of the depth-sensing camera and each point on the object in the image, wherein the person is detected according to the distance information of the object in the image.

18. The storage medium of claim 13, wherein each of the depth-sensing cameras is a time-of-flight (TOF) camera.
